(19) United States
(12) Patent Application Publication
(10) Pub. No.: US 2005/0212249 A1
(43) Pub. Date: Sep. 29, 2005

(54) Lighted vehicle step bar

(76) Inventor: Roberto Lopez, El Paso, TX (US)

Correspondence Address: Richard C. Litman;LITMAN LAW OFFICES, LTD., P.O. Box 15035, Arlington, VA, 22215, US

(21) Appl. No.: 10/807,430

(22) Filed: Mar. 24, 2004

(51) Int. Cl. B60R 3/00

(52) U.S. Cl. 280/164.1

(57) ABSTRACT

The lighted vehicle step bar has a tongue adapted to be received by a standard vehicular hitch receiver and a bar extending perpendicularly thereto. The bar is fixed to the tongue at a free end thereof. A left and a right signal lamp are disposed at respective sides of a rear-facing wall of the bar. The signal lamps face rearwardly of the bar. The signal lamps are wired to a standard trailer plug, which is adapted to connect the left and right signal lamps into vehicle turn signal lamp circuits.

### BACKGROUND OF THE INVENTION

1. Field of the Invention

The present invention relates to a lighted vehicle step bar for accessing the interior or roof of trucks and other tall vehicles.

2. Description of the Related Art

Accessing the interior of a pickup truck or delivery van can be difficult and strenuous when the lowest stepping surface is also the top of the bumper. This is particularly true for taller pickup trucks and vans. In addition, owners of sport utility vehicles often have difficulty accessing the roof of their vehicle, be it for securing or removing an item from a roof rack, cleaning the roof, or clearing snow and ice from the roof, as is now required by law in some areas.

Exemplary related art addressing this problem includes the device described in U.S. Pat. No. 5,829,774, issued Nov. 3, 1998 to Klemp. This device comprises a round metal bar having a centrally located square tongue extending perpendicularly therefrom. The tongue mates with a standard two-inch square hitch receiver such that the metal bar extends behind and slightly below the rear bumper. The top of the metal bar includes two depressions which may be covered with a skid resistant material and used as steps.

A similar device is commercially available from ETRAILER.COM and is sold as a “Round Tube Stainless Steel Trailer Hitch Receiver Step”. This device has ends that curve forward towards the vehicle and has plastic endcaps.

Another example of related art is U.S. Pat. No. 6,491,315, issued Dec. 10, 2002 to Hagen et al. This device, aside from providing a stepping surface, includes illuminated brake lights.

While the above devices function suitably well for their intended purpose, they do not provide both a broad stepping surface as may be required coupled with the additional benefits of supplemental illuminated turn signals integrated with the step bar.

None of the above inventions and patents, taken either singly or in combination, is seen to describe the instant invention as claimed. Thus a lighted vehicle step bar solving the aforementioned problems is desired.

### SUMMARY OF THE INVENTION

The lighted vehicle step bar of the present invention comprises a tongue adapted to be received by a standard vehicular hitch receiver and a bar extending perpendicularly thereto. The bar is fixed to the tongue at a free end thereof. A left and a right signal lamp are disposed at respective sides of a rear-facing wall of the bar. The signal lamps face rearwardly of the bar. The signal lamps are wired to a standard trailer plug, which is adapted to connect them into vehicle turn signal lamp circuits.

These and other features of the present invention will become readily apparent upon further review of the following specification and drawings.

### BRIEF DESCRIPTION OF THE DRAWINGS

FIG. 1 is an environmental, perspective view of a lighted vehicle step bar according to the present invention.

FIG. 2 is a perspective view of the lighted vehicle step bar according to the present invention.

FIG. 3 is a top view of the lighted vehicle step bar according to the present invention.

FIG. 4 is a rear elevational view of the lighted vehicle step bar of FIGS. 1-3.

FIG. 5 shows an alternate embodiment of a lighted vehicle step bar according to the present invention.

Similar reference characters denote corresponding features consistently throughout the attached drawings.

### DETAILED DESCRIPTION OF THE PREFERRED EMBODIMENTS

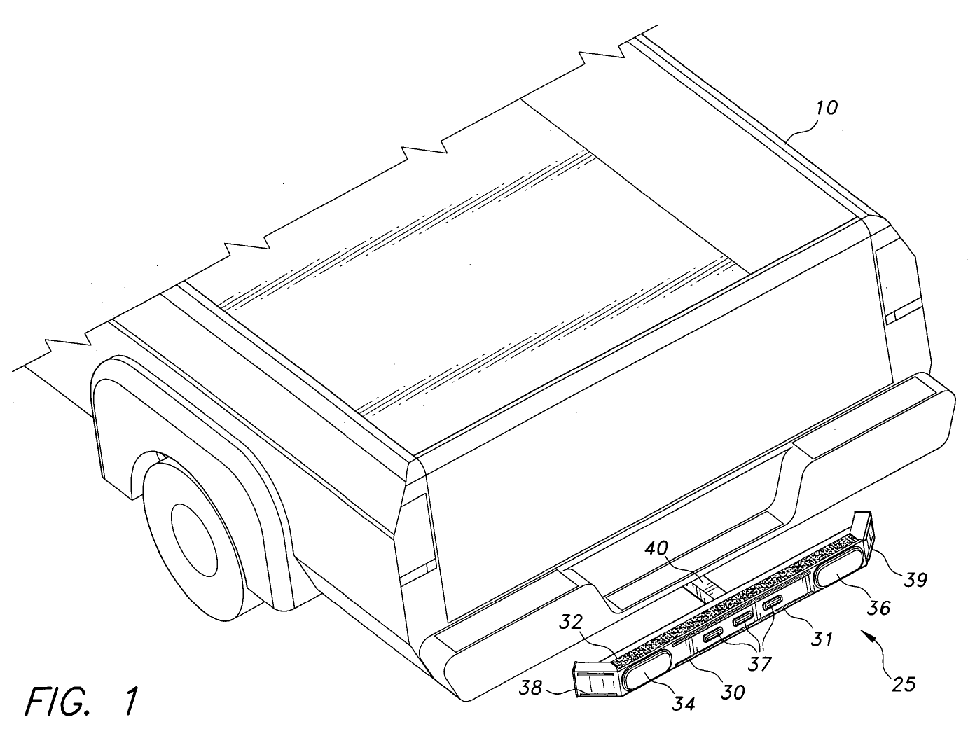

FIG. 1 shows a lighted vehicle step bar 25 of the present invention attached to a vehicle 10. As shown in FIG. 1, vehicle 10 is a pickup truck and step bar 25 allows a person to readily access the interior or bed thereof. However, vehicle 10 may be any type of vehicle where step bar 25 would be helpful. For example, step bar 25 would also ease entry into the cargo area of a van and allow easier access to the roof of a sport utility vehicle or other like vehicle with a high roof.

Step bar 25 comprises a generally horizontally extending step portion 30 and a centrally located tongue 40 extending forward and perpendicularly to step portion 30. Step portion 30 is preferably formed from a 14 gauge (1.6 mm thick) 2×4 inch (5 cm by 10 cm) or 2×3 inch (5 cm by 8 cm) bar of rectangular steel tubing with an applied chrome trim. Decorative chrome trim molding 31 is applied to the chrome trim to further improve its appearance. Tongue 40 may be formed of 14 gauge 2×2 or 1.25×1.25 inch steel tubing or other high-strength material, and is adapted for attachment to a conventional vehicle receiver hitch by use of a hitch pin or the like.

Step portion 30 has a top surface 32. Top surface 32 has a non-slip surface or tread which may be applied by adhesive or otherwise formed into the material of step portion 30. For example, non-slip surface may be diamond plate welded to step portion 30 which is then optionally coated with a spray on non-slip material. Optionally, a hard rubber tread may be adhesively applied to step portion 30, etc.

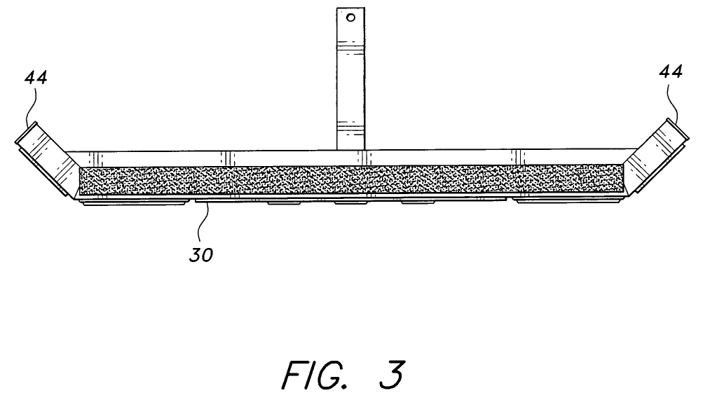

Step portion 30 also includes a left end 38 and a right end 39 which are angled forward about 45° toward vehicle 10. Left and right ends 38, 39 reduce the likelihood of injury by reducing the corners. If a person is walking around the back of vehicle 10, ends 38, 39 will protect his or her legs from banging directly into a hard flat surface at the either end of step bar 25. Plastic endcaps 44, shown in FIG. 3, are friction-fit and/or glued to the open ends of ends 38, 39, to protect the interior of step bar 25 from dirt and moisture.

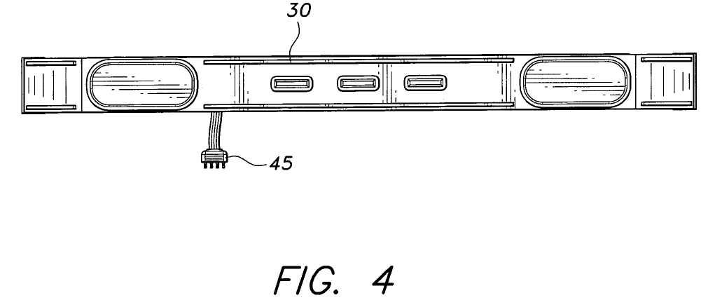

Step bar 25 includes left signal lamp 34, right signal lamp 36, and running lamps 37 disposed in apertures formed in the rear wall of step portion 30 of step bar 25. To make these lamps part of the electrical system of vehicle 10, step bar 25 may be electrically connected to vehicle's electrical system using plug 45, seen in FIG. 4, which may be a standard vehicle trailer connector. When so attached, left and right signal lamps 34 and 36 and running lamps 37 will dimly illuminate when running lamps of vehicle 10 are turned on. In addition, left and right signal lamps 34 and 36 are connected for turn signal functionality. When the driver actuates the left turn signal, left lamp 34 will flash brightly, and when the driver actuates the right turn signal, right lamp 36 will flash brightly. For additional functionality, left and right signal lamps 34 and 36 may be connected to the vehicle's brake light circuit. In this instance, left and right signal lamps 34, 36 will illuminate brightly when the driver applies the brakes.

Step bar 25, by providing a step portion of about thirty-six inches (91 cm) and ends 38, 39 about five inches (13 cm) provides good utility by providing a wide step portion and yet still more than sufficient strength to support a person's weight on one of the ends 38, 39.

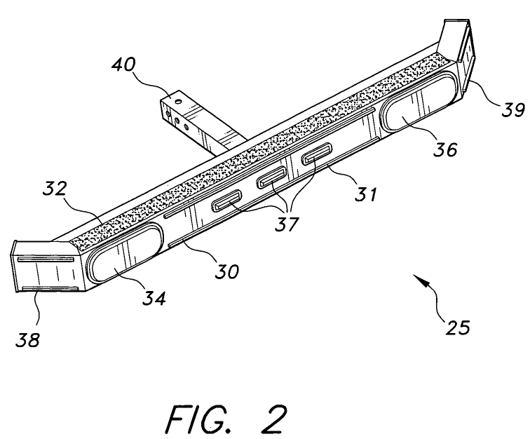

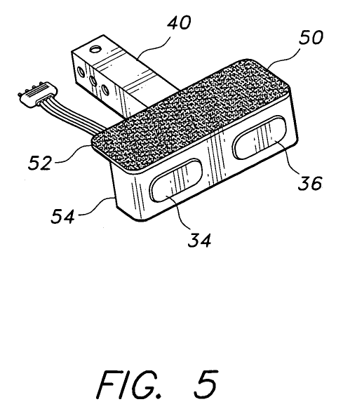

FIG. 5 shows an alternative embodiment of a lighted vehicle step bar 50 that has a shorter length than the embodiment shown in FIGS. 1-4. In this embodiment, step bar 50 is between ten and twenty inches (25-50 cm) long; preferred lengths are ten inches (25 cm) and fourteen inches (36 cm). Step surface 52 is diamond plate steel, is four inches (10 cm) deep and as wide as housing 54, which supports left and right lamps 34, 36. Housing 54 may be made of steel or other material with exemplary dimensions of about two inches (5 cm) deep and three inches (8 cm) tall. Other materials, such as composite plastic or other high-strength durable material, as would occur to a person of ordinary skill in the art are also contemplated. Furthermore, the specific dimensions should not be construed as limiting, but are presented for exemplary purposes only. Left and right lamps 34, 36 operate in the same manner discussed above with respect to the embodiment shown in FIGS. 1-4.

Step bar 25 shown in FIGS. 1-4 and step bar 50 shown in FIG. 5, in addition to easing access to higher parts of vehicle 10, increase the visibility, and therefore the safety, of vehicle 10. The implementation of turn signals into the step bars provide enhanced functionality and improved safety.

It is to be understood that the present invention is not limited to the embodiments described above, but encompasses any and all embodiments within the scope of the following claims.

1. A lighted vehicle step bar, comprising:
a tongue adapted for attachment to a receiver hitch mounted on a vehicle;
a bar extending perpendicularly from said tongue and forming a step, said bar being fixed to said tongue, the bar having a rear-facing wall;
a left signal lamp and a right signal lamp disposed at a left side and right side, respectively, of the rear-facing wall of said bar, said left signal lamp and said right signal lamp facing rearwardly of said bar; and
wiring connecting said left signal lamp and said right signal lamp to a standard trailer plug, said trailer plug being adapted for electrically connecting said left signal lamp and said right signal lamp to a respective one of a left and right turn signal lamp circuit of the vehicle.

2. The step bar of claim 1 wherein said trailer plug is adapted for electrically connecting said left signal lamp and said right signal lamp to a brake light circuit of the vehicle.

3. The step bar of claim 1, further comprising a non-slip surface disposed on a top surface of said bar.

4. The step bar of claim 3, wherein said non-slip surface is adhesively attached to said bar.

5. The step bar of claim 3, wherein said non-slip surface comprises diamond plate.

6. The step bar of claim 1, wherein said bar has a left end and a right end, the left end and the right end extending outwardly and rearwardly of said step bar from the ends of said bar.

7. The step bar of claim 6, wherein the left end and the right end extend at about a 45° angle from said bar.

8. The step bar of claim 1, further including at least one running lamp disposed between said left signal lamp and said right signal lamp, said at least one running lamp being electrically connected to said trailer plug.

9. The step bar of claim 1, wherein said tongue has a plurality of through holes defined therein adapted for enabling a plurality of positions within said hitch receiver.

10. The step bar of claim 1, wherein said bar is formed by 2×4 inch rectangular steel tubing.

11. The step bar of claim 1, wherein said bar is formed by 2×3 inch rectangular steel tubing.
